(19) United States
(12) Patent Application Publication
(10) Pub. No.: US 2022/0286283 A1
(43) Pub. Date: Sep. 8, 2022

(54) Secure Recovery of Security Credential Information

(71) Applicant: SOFTIRON LIMITED, Chilworth (GB)

(72) Inventors: Charles C. Ruffino, Menifee, CA (US); Stephen Hardwick, Austin, TX (US); Mark Chen, Newark, CA (US)

(73) Assignee: SOFTIRON LIMITED, CHILWORTH (GB)

(21) Appl. No.: 17/688,205

(22) Filed: Mar. 7, 2022

Related U.S. Application Data
(60) Provisional application No. 63/158,114, filed on Mar. 8, 2021.

(51) Int. Cl. H04L 9/08

(52) U.S. Cl. CPC H04L 9/0894; H04L 9/085; H04L 9/0891; H04L 9/0825

(57) ABSTRACT

A system includes a shard generation circuit configured to create shards from a security credential, and to recreate the security credential from the shards. The system includes a secret generation circuit configured to create secrets from a shard and to recreate the shard from a subset of the secrets, and store at least one of secrets in a location. The system includes another secret generation circuit configured to create secrets from another shard, recreate the other shard of the shards, and store at least one the shards in another, different location.

### PRIORITY

This application claims priority to U.S. Provisional Patent Application No. 63/158,114 filed Mar. 8, 2021, the contents of which are hereby incorporated in their entirety.

### FIELD OF THE INVENTION

The present disclosure relates to electronic data storage and, more particularly, to secure recovery of security credential information.

### BACKGROUND

Data erasure of software defined storage (SDS) information at the storage level can be difficult to achieve. Ensuring that data can be securely destroyed in an SDS implementation can be difficult to achieve. The challenge is that the system is designed to specifically overcome the loss of data. The system may include several storage devices assembled into a cluster. A well accepted method of erasing data is to use a cryptographic erase. This may involve encrypting data that is written onto a storage device and then securely deleting the key. A common issue in cryptographic erase is how to recover the storage encryption key if the storage encryption key is accidentally destroyed.

There are many instances where storing a security credential is problematic. A security credential may be stored so as to provide a backup in case an erase of the credential was made accidentally, wherein such an erase might otherwise have been intended to perform, for example, a secure erase. Take as an example, use of encryption keys to protect the contents of a storage medium. To perform a cryptographic erasure, all copies of the data encryption key must be destroyed. However, many users may be worried that accidental destruction of the key would result in the lack of access to the data on the encrypted medium. Consequently, copies of the encryption key might be stored elsewhere. However, storing additional keys in other locations might itself present a security threat.

Embodiments of the present disclosure may address one or more of these challenges with improved key restoration techniques.

### BRIEF DESCRIPTION OF THE DRAWINGS

FIG. 1 is an illustration of a process for generating a distributed secret for a security credential, according to embodiments of the present disclosure.

FIG. 2 is an illustration of a process for recovering or reconstituting a distributed secret for a security credential, according to embodiments of the present disclosure.

FIG. 3 is an illustration of systems for generating and recovering a distributed secret for a security credential, according to embodiments of the present disclosure.

FIG. 4 is an illustration of an example system using of an NFC card for generating and recovering a distributed secret for a security credential, according to embodiments of the present disclosure.

FIG. 5 is an illustration of an example method for generating a distributed secret for a security credential, and recovering or reconstituting a distributed secret for a security credential, according to embodiments of the present disclosure.

### DETAILED DESCRIPTION

Embodiments of the present disclosure include methods for reconstitution of security credentials. Such credentials may be used, for example, for securing data storage. The intentional deletion of such credentials may be used in a secure erase process. Embodiments of the present disclosure may utilize multiple types of credentials to reconstitute the original security credential. As can also be seen in the discussion below, this may create different distribution mechanisms that provide some distinct advantages.

By using threshold encryption, a single security credential can be split into multiple parts. The parts can either be made up of derivatives of the original, e.g., sharding, or used to derive distinctly different values, e.g., Shamir's Secret Sharing Scheme. If a simple sharding method is used, all of the derivatives or shards may be required to generate the original. In secret sharing schemes, only a subset of the derivatives or secrets may be required to generate the original. Therefore, if N derivatives of the original data are created, then for a given scheme, T_{N} may denote how of those N derivatives that may be needed to reconstitute the original data. In the case of simple sharding, the number of derivatives is equal to the number required to reconstitute, e.g., N=T_{N}. In a secret sharing scheme, the number of required derivatives to reconstitute the original data can be less than or equal to the total number of derivatives that are generated, e.g., N≥T_{N}.

Embodiments of the present disclosure may include an apparatus. The apparatus may include a shard generation circuit, a first secret generation circuit, and a second secret generation circuit. The shard generation circuit, first secret generation circuit, and second secret generation circuit may be implemented by analog circuitry, digital circuitry, control logic, instructions for execution by a processor, digital logic circuits programmed through hardware description language, application specific integrated circuits, field programmable gate arrays, programmable logic devices, or any suitable combination thereof, whether in a unitary device or spread over several devices. Moreover, one or more of these circuits may be implemented in a single or multiple components.

The shard generation circuit may be configured to create shards from a security credential. As discussed above, when N=T_{N}, simple sharding may be used, wherein all shards are needed to reconstitute the original security credential. A shard may include any suitable derivative of a security credential that, when all or a sufficient number of such shards are available, the security credential may be reconstituted or recreated. The shards may be implemented in any suitable information representation. The security credential may include any suitable information for authentication, such as a cryptographic key that is symmetric or asymmetric, or public or private, or a cryptographic hash, password, or passcode. The shard generation circuit may be configured to later recreate the security credential from the plurality of shards that were generated. The shard generation circuit may recreate the security credential by having access to all of the shards that were generated.

The first secret generation circuit may be configured to create a plurality of first secrets from a first shard of the shards generated by the shard generation circuit. The first secret generation circuit may be configured to later recreate the first shard of the plurality of shards from a subset of the plurality of secrets. The secrets may be implemented in any suitable information representation. A secret may include any suitable derivative of a security credential that, when all or a sufficient number of such shards are available, the security credential may be reconstituted or recreated. The first secret generation circuit may be configured to store at least one of the plurality of first secrets in a first location.

The second secret generation circuit may be configured to create a plurality of second secrets from a second shard of the plurality of shards, and to later recreate the second shard of the plurality of shards from a subset of the plurality of second secrets. The second secret generation circuit may be configured to store at least one of the plurality of second secrets in a second location. The second location in a different machine than the first location.

In combination with any of the above embodiments, the first secret generation circuit may use a threshold encryption P≥T_{P} function, wherein the encryption generates P secrets, and a threshold number, T_{P}, of those secrets may be needed to reconstitute or reconstruct the original shard from which the secret generation circuit generated the secrets.

In combination with any of the above embodiments, the first secret generation circuit may use a threshold encryption Q≥T_{Q} function, wherein the encryption generates Q secrets, and a threshold number, T_{Q}, of those secrets may be needed to reconstitute or reconstruct the original shard from which the secret generation circuit generated the secrets. In various embodiments, the threshold encryption functions may be different between the generation circuits, and P and Q may be different numbers.

In combination with any of the above embodiments, the shard generation circuit may be configured to destroy the security credential after creation of the plurality of shards as part of a secure erase of data protected by the security credential.

In combination with any of the above embodiments, the second location may be a remote location to the system, and the second secret generation circuit may be further configured to store at least a second one of the plurality of second secrets in a third location, wherein the third location a remote location to the system and in a different machine than the second location.

In combination with any of the above embodiments, the first location may be local to the system.

In combination with any of the above embodiments, the plurality of first secrets may be independent of a machine on which the secrets reside.

In combination with any of the above embodiments, the plurality of second secrets may be dependent upon a machine on which the secrets reside.

In combination with any of the above embodiments, the apparatus may include an encryption circuit configured to encrypt the plurality of first secrets. The encryption circuit may be configured to decrypt encrypted first secrets. The encryption circuit may be implemented by analog circuitry, digital circuitry, control logic, instructions for execution by a processor, digital logic circuits programmed through hardware description language, application specific integrated circuits, field programmable gate arrays, programmable logic devices, or any suitable combination thereof, whether in a unitary device or spread over several devices.

In combination with any of the above embodiments, the encryption circuit may be configured to store the plurality of first secrets as encrypted on the system, and to provide the plurality of second secrets to the second location and a third location.

In combination with any of the above embodiments, the first secret generation circuit may be configured to store the plurality of first secrets as encrypted on the system. In combination with any of the above embodiments, the second secret generation circuit may be configured to provide the plurality of second secrets to the second location and a third location.

In combination with any of the above embodiments, the encryption circuit may be further configured to apply a different asymmetric encryption credential to each of the plurality of first secrets to encrypt each of the plurality of first secrets.

In combination with any of the above embodiments, a private asymmetric encryption credential corresponding to a public asymmetric encryption credential used to encrypt at least one of the plurality of the first secrets may be stored on a remote machine.

In combination with any of the above embodiments, the encryption circuit may be further configured to apply a first asymmetric encryption credential to a first one of the first secrets to encrypt the first one of the first secrets, and to apply a second asymmetric encryption credential to a second one of the first secrets to encrypt the second one of the first secrets. A first private key corresponding to the first asymmetric encryption credential may be stored on a first remote location. A second private key corresponding to the second asymmetric encryption credential may be stored on a second remote location. The second remote location may be different than the first remote location.

In combination with any of the above embodiments, the asymmetric encryption credentials to encrypt the first secrets may be stored internally to the apparatus.

In combination with any of the above embodiments, the security credential might not be stored remotely outside of the system.

In combination with any of the above embodiments, the shard generation circuit may be further configured to require regeneration of the first shard created as a server-independent shard and regeneration of the second shard created as a server-independent shard in order to recreate the security of shards from a security credential.

In combination with any of the above embodiments, the first secret generation circuit may be further configured to recreate the first shard of the plurality of shards only when a minimum number of the subset of the plurality of secrets are presented.

In combination with any of the above embodiments, the first secrets may be stored internally to the system and are device or server-independent.

In combination with any of the above embodiments, the second secrets may be stored externally to the system and are device or server-dependent.

In combination with any of the above embodiments, internally stored secrets may be only decryptable with a locally provided device. The device may be, for example, a smart card.

In combination with any of the above embodiments, the shard generation circuit may be configured to erase the security credential after creating the plurality of shards.

In combination with any of the above embodiments, the shard generation circuit may be configured to erase plurality of shards after recreating the security credential. This may be part of a secure erase.

In combination with any of the above embodiments, the first secret generation circuit may be configured to erase the first shard after creating the plurality of first secrets.

In combination with any of the above embodiments, the first secret generation circuit may be configured to erase the plurality of first secrets after recreating the first shard. This may be part of a secure erase.

In combination with any of the above embodiments, the second secret generation circuit may be configured to erase the plurality of second secrets after storing the plurality of second secrets in the second location. This may be part of a secure erase.

In combination with any of the above embodiments, secrets may be stored externally to the apparatus and encrypted secrets may be stored internally to the apparatus. Public keys may be used to perform the encryption. Public keys may be stored on the apparatus. The same public keys may be used to encrypt secrets for multiple apparatuses. Private keys to decrypt secrets may be stored externally. The private keys may be used to thus decrypt secrets for multiple apparatuses. Therefore, in this example, the private key is independent of the apparatus and tied to the owner of that key. This may be considered a device-independent or server-independent zone. However, secrets stored externally to the apparatus may be provided back to the apparatus for deletion. The secret for a given apparatus cannot be used on other apparatuses. This may be considered a device-dependent zone or server-dependent zone. For a given shard, at least one secret may be stored in a device-dependent zone and at least one secret may be stored in a device-independent zone.

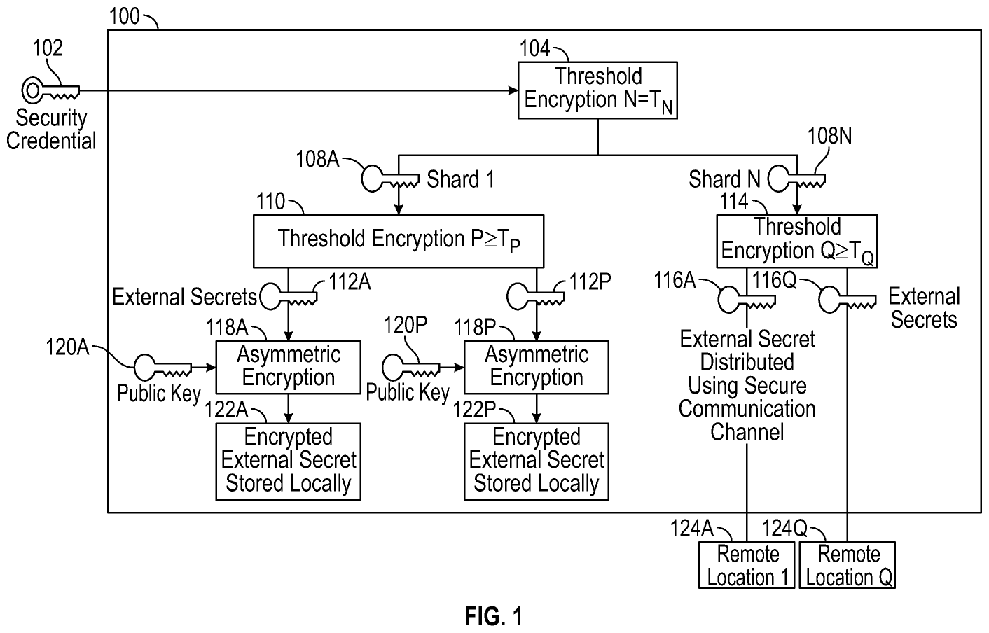

FIG. 1 is an illustration of a process for generating a distributed secret for a security credential, according to embodiments of the present disclosure.

As shown in FIG. 1, a security credential 102 is provided to a system 100. System 100 may be a threshold encryption system. System 100 may include a processor (not shown) and a machine-readable, non-transitory medium (not shown). The medium may include instructions that, when loaded and executed by the processor, may cause system 100 to perform the functionality as described herein. Moreover, the functionality described herein may be implemented in any suitable manner, such as by analog circuitry, digital circuitry, control logic, instructions for execution by a processor, digital logic circuits programmed through hardware description language, application specific integrated circuits (ASIC), field programmable gate arrays (FPGA), programmable logic devices (PLD), or any suitable combination thereof, whether in a unitary device or spread over several devices.

System 100 may be configured to convert a security credential 102 using threshold encryption function circuit 104.

Security credential 102 may include any suitable information for authentication. Security credential 102 may include, for example, a cryptographic key. The key may be symmetric or asymmetric, and public or private. In other cases, security credential 102 may include, for example, a cryptographic hash, password, or passcode.

Function circuit 104 may be implemented in any suitable manner, such as by instructions in the medium for execution by the processor, a function, library call, subroutine, shared library, software as a service, analog circuitry, digital circuitry, control logic, digital logic circuits programmed through hardware description language, ASIC, FPGA, PLD, or any suitable combination thereof, or any other suitable mechanism, whether in a unitary device or spread over several devices.

Function circuit 104 may be used for use cases wherein N=T_{N}. As discussed above, when N=T_{N}, simple sharding may be used, wherein all shards are needed to reconstitute the original security credential. Function circuit 104 may be configured to convert security credential 102 into multiple shards 1 (108A) through N (108N). Although a shard is shown as the derivative of security credential 102, any suitable derivative of security credential 102 may be used. Function circuit 104 may be performed in such a way that the number of shards created by function circuit 104 is equal to the number of shards required to reconstitute security credential 102. Therefore, if N derivatives are created by the application of function circuit 104 security credential 102, and T_{N} derivatives are needed to reconstitute security credential 102, then N=T_{N}. Function circuit 104 may perform this in any suitable manner. Function circuit 104 may perform this by splitting an initial copy of security credential 102 into subsets of the original data by using filters to generate shards 108A-108N. Once shards 108A-108N are created, the original copy of security credential 102 may be completely destroyed by, for example, being overwritten.

Next, threshold encryption P≥T_{P} function circuit 110 and threshold encryption Q≥T_{Q} function circuit 114 may be configured to create derivatives from each of shards 108A, 108N. More functions, not shown, may be used to create derivates from the intervening shards between shards 108A, 108N. Each such function may have its own quantity of derivates created (such as P or Q) and corresponding threshold values (such as T_{P} or T_{Q}). Function circuits 110, 114 and other functions not shown for creating derivatives from shards 108 may be implemented in any suitable manner, such as by instructions in the medium for execution by the processor, a function, library call, subroutine, shared library, software as a service, analog circuitry, digital circuitry, control logic, digital logic circuits programmed through hardware description language, ASIC, FPGA, PLD, or any suitable combination thereof, or any other suitable mechanism, whether in a unitary device or spread over several devices. Function circuits 110, 114 and other functions not shown for creating derivatives from shards 108 may create derivatives such that fewer derivatives, given by T, are needed to reconstitute the original input. For function circuits 110, 114, the original input is given by P and Q, respectively. Thus, function circuits 110, 114 may be referred to as P≥T_{P} and Q≥T_{Q}, respectively. Function circuit 110 may be configured to generate a quantity (P) of secrets 112A-112P from shard 108A. Similarly, function circuit 114 may be configured to generate a quantity (Q) of secrets 116A-116Q from shard 108N. Other functions not shown for creating derivatives from shards 108 may similar quantities of secrets from respective shards 108 that are greater than the number of derivatives needed to reconstitute the respective shard 108. Function circuits 110, 114 may use, for example, Shamir's Secret Sharing Scheme to generate the secrets from the shards. The secrets may be implemented in any suitable information representation. The actual value for P or Q, or for the other functions not shown, can differ with each function. Furthermore, P, Q, and T can be different for different instances or applications of a given function.

Thus, P secrets 112 may be generated for shard 108A, and Q secrets 116 may be generated for shard 108N. Not shown are secrets generated for each of the intervening shards 108 (not shown). Secrets 112, 116, and those not shown may be considered to be local secrets or external secrets. A local secret may be stored locally to system 100 for retrieval upon reconstitution of security credential 102. An external secret may be stored externally to system 100 for retrieval upon reconstitution of security credential 102. Secrets 112, 116, and those not shown may be stored in any suitable manner.

In one example, secrets 112, 116, and those not shown may be distributed securely to a remote location using a secure communications channel. Each of secrets 112, 116, and those not shown that are exported may sent to a different remote location. For example, secret 116A may be sent to a remote location 1 124A. Furthermore, external secret 116Q may be sent to remote location 124Q. Local copies of secrets 116A-116Q may destroyed once they have been successfully deposited in remote locations. Remote locations 124 may include any suitable sever, storage, or other system for storing data or information.

In another example, secrets 112, 116, and those not shown may be stored locally. These may be stored in an encrypted manner. For example, secrets 112 may be stored locally in system 100. Each of secrets 112A-112P may have an individual instance of a public key 120A-120P associated with it. There may be a corresponding private key for each public key, as discussed further below. Using asymmetric encryption circuit 118, public keys 120 may be used to create encrypted copies 122 of respective secrets 112. Asymmetric encryption circuit 118 may be implemented in any suitable manner, such as by instructions in the medium for execution by the processor, a function, library call, subroutine, shared library, software as a service, analog circuitry, digital circuitry, control logic, digital logic circuits programmed through hardware description language, ASIC, FPGA, PLD, or any suitable combination thereof, or any other suitable mechanism, whether in a unitary device or spread over several devices. Respective ones of secrets 112 may be destroyed once respective ones of encrypted copies 122 have been created.

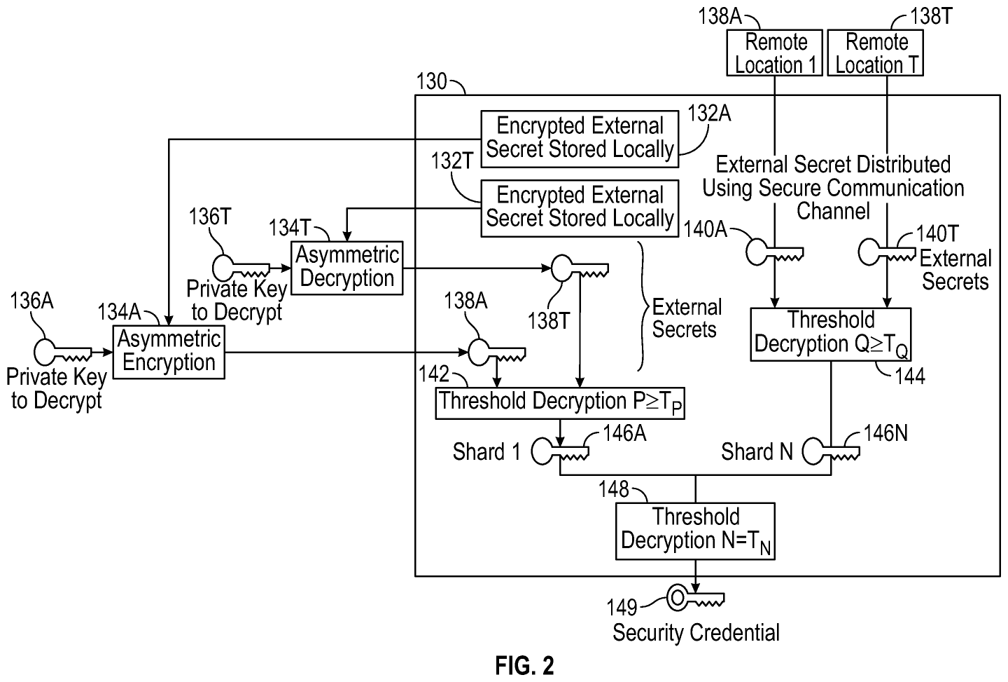

FIG. 2 is an illustration of a process for recovering or reconstituting a distributed secret for a security credential, according to embodiments of the present disclosure. The security credential may have been securely destroyed. Illustrated in FIG. 2 for recovering or reconstituting a distributed secret for a security credential is a threshold decryption system 130. System 130 may be implemented within system 100, or implemented in a manner that is communicatively coupled and will work with system 100. Threshold decryption system 130 may be implemented in any suitable manner, such as by instructions in the medium for execution by the processor, a function, library call, subroutine, shared library, software as a service, analog circuitry, digital circuitry, control logic, digital logic circuits programmed through hardware description language, ASIC, FPGA, PLD, or any suitable combination thereof, or any other suitable mechanism, whether in a unitary device or spread over several devices.

First, any encrypted copies of secrets that were created as shown in FIG. 1 may be restored. As discussed above, it was shown that N shards were created. Then, secrets were created for each shard. The number of secrets created for each shard depended upon the threshold encryption used. A set of quantity P secrets was created by threshold encryption P≥T_{P} function circuit 110 and a set of quantity Q secrets was created by threshold encryption function Q≥T_{Q} circuit 114. Since creation of secrets was done, for example, using threshold encryption (P≥T_{P}, Q≥T_{Q}), only a subset T (which may vary from function to function, such as T_{P} or T_{Q}) of the original quantity of secrets are needed to recreate the shard. For example, in FIG. 1, shard 1 108A was split by threshold encryption P≥T_{P} function circuit 110 into a set of P external secrets 112. Even though a total number of P secrets of secrets 112 were generated, only a total number of T_{P} secrets of secrets 112 are required to regenerate shard 1 108A. Similarly, a total number of Q secrets of secrets 116 were generated from shard N 108N, and only a total number of T_{P} secrets of secrets 116 are required to regenerate shard N 108N. Since in threshold encryption circuit 104, N=T_{N}, all shards 1 through N are required to reconstitute security credential 102.

Encrypted external secret stored locally 122A was generated using asymmetric encryption circuit 118A and public key 120A on secret 112A. To restore the locally encrypted secrets, for example, an external secret stored locally 132A may be decrypted off-site. Secret 132A may be sent to an external asymmetric decryption circuit 134A from threshold decryption system 130.

At external asymmetric decryption circuit 134A, using private key 136A, external secret 138A may be decrypted and sent back to threshold decryption system 130. Decryption circuit 134A may use the same algorithm as was used in the asymmetric encryption (such as encryption circuit 118A) used to create secret 132A. Secret 138A may be the reconstitution of one of secrets 112, such as secret 112A. Similarly, encrypted external secret stored locally 132T may be sent to an external asymmetric decryption circuit 134T from threshold decryption system 130. Here, using private key 136T, secret 138T may be decrypted and sent back to threshold decryption system 130. Secret 138T may be the reconstitution of one of secrets 112, such as secret 112P. Moreover, additional intervening encrypted external secrets stored locally 132 (not shown) may be reconstituted using respective asymmetric decryption circuits 134 (not shown) using respective private keys 136 (not shown). There may be T_{P} secrets 138 to reconstitute the original shard using threshold decryption function P≥T_{P} circuit 142. If threshold decryption function P≥T_{P} circuit 142 reconstitutes secrets generated by function threshold encryption function P≥T function circuit 110, then threshold decryption function P≥T_{P} circuit 142 may use a threshold of T_{P} secrets 138. Again, T_{P} may be less than P, the total number of secrets derived from the original shard. _{P}

Because the set of T_{P} secrets 138 that are reconstituted from encrypted external secrets stored locally 132 may be smaller or equal than the number of P secrets 112 that were originally generated, secret 138A might not necessarily correspond, specifically, to secret 112A, and vice-versa; encrypted external secret stored locally 122A might not necessarily correspond, specifically, to encrypted external secret stored locally 132A, and vice-versa; asymmetric decryption circuit 134A might not necessarily correspond, specifically, to asymmetric encryption circuit 118A, and vice-versa; public key 120A might not necessarily correspond, specifically, to private key 136A, and vice-versa. However, each of secrets 112 will correspond to one or more of secrets 138; each of asymmetric encryption circuit 118 will correspond to one or more of asymmetric decryption circuit 134; each of encrypted external secrets stored locally 122 will correspond to one or more of encrypted external secrets stored locally 132; each of private keys 136 will correspond to one or more of public keys 120; each of secrets 138 will correspond to one or more of secrets 112; each of asymmetric decryption circuit 134 will correspond to one or more of asymmetric encryption circuit 118; each of encrypted external secrets stored locally 132 will correspond to one or more of encrypted external secrets stored locally 122; and each of public keys 120 will correspond to one or more of private keys 136. The “one or more” correspondence between the elements of FIGS. 1 and 2 depends upon whether any keys or encryption/decryption routines are reused for multiple secrets.

Next, using secrets 138A-138T (which are a subset of a total number of secrets 138A-138P), a shard 1 146A can be reconstituted using threshold decryption P≥T_{P} function circuit 142. Shard 1 146A may correspond to shard 1 108A in FIG. 1. Once shard 1 146a has been created, secrets 138A-138T used to reconstitute may be securely destroyed.

Other secrets that have been remotely stored may be retrieved from various external locations 138 where they are stored. Note only T locations might need to return secrets, wherein T corresponds to the threshold of the function used to generate the secrets stored in external locations. Therefore, remote locations 138A-138T may supply secrets 140A-140T to threshold decryption system 130. These may be provided through a secure or encrypted communications channel. Using secrets 140, the original shard N 146N can be reconstituted using threshold decryption function Q≥T_{Q} circuit 144. Once shard N 146N has been created, all secrets 140 used to reconstitute may be securely destroyed. There may be T_{Q} secrets 140 to reconstitute the original shard using threshold decryption function Q≥T_{Q} circuit 144. If threshold decryption function Q≥T_{Q} circuit 144 reconstitutes secrets generated by function threshold encryption function Q≥T_{Q} circuit 114, then threshold decryption function Q≥T_{Q} circuit 144 may use a threshold of T_{Q} secrets 140.

Because only a subset of secrets (such as quantity T_{Q}) is needed to reconstitute the shard, only a subset of remote locations 138 (quantity T_{Q}) need to yield the remotely stored secrets. Accordingly, remote locations 124 may correspond to various ones of remote locations 138, though not necessarily in a 1:1 manner. Each of remote locations 124 may correspond to one or more of remote locations 138, and vice-versa. Each of secrets 140 may correspond to one or more of secrets 116, and vice-versa.

Although generation of shard 1 146A through use of locally stored secrets 132 and shard N 146N through use of remotely stored secrets 140 are shown, generation of shards 146 may be performed through any suitable combination of locally or remote stored secrets. These are provided as a mere example. Generation of other shards 146 are not shown in FIG. 2 but may be performed in any suitable manner. N shards 146 may be reconstituted, corresponding to shards 108.

Shards 146 may be used by threshold decryption N=T_{N} function circuit 148 to reconstitute a security credential 149. Security credential 149, if correctly reconstituted, may be the same as security credential 102. All of the N shards 108 that were created in FIG. 1 by threshold encryption function circuit 104 may be presented to threshold decryption N=T_{N} function circuit 148 to successfully reconstitute security credential 149. Once security credential 149 has been created, shards 146 may be securely destroyed.

It can be seen from the examples above that there are different methods to distribute the secrets. Although locally encrypted versions and remote storage were used, any other suitable methods may be employed. In one embodiment, the type of distribution may be common to a given shard. For example, secrets 112 derived from shard 1 108A may be encrypted and stored locally, while secrets 116 derived from shard N 108N may be stored remotely. As such a given shard and its associated secrets can be grouped in a “zone.” The shard for each zone can be named the zone shard for that particular zone.

Circuits 134, 142, 144, 148 may be implemented in any suitable manner, such as by instructions in the medium for execution by the processor, a function, library call, subroutine, shared library, software as a service, analog circuitry, digital circuitry, control logic, digital logic circuits programmed through hardware description language, ASIC, FPGA, PLD, or any suitable combination thereof, or any other suitable mechanism, whether in a unitary device or spread over several devices.

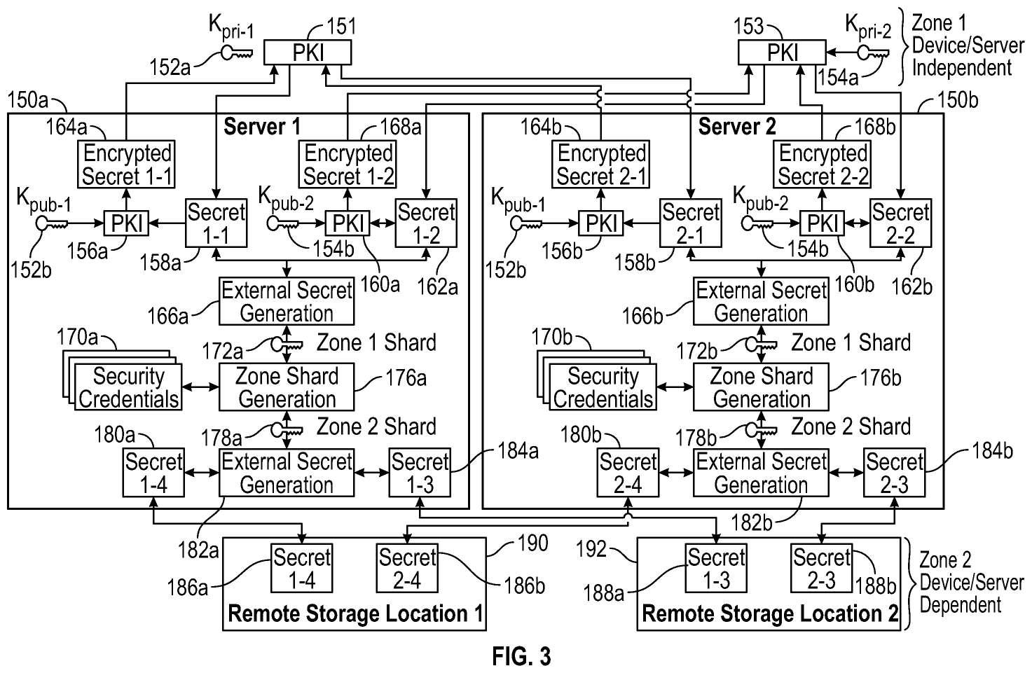

FIG. 3 is an illustration of systems for generating and recovering a distributed secret for a security credential, according to embodiments of the present disclosure. FIG. 3 illustrates two distribution mechanisms. One such distribution may be performed with public key infrastructure (PKI), and another such distribution may be to distribute the secrets to multiple servers. The multiple servers may be in remote storage locations. Shown in FIG. 3 are two zones, one for each of the example distribution mechanisms. Although there are only two zones shown for the sake of clarity, there is no limit to the number, type, and combination of zones that can be implemented.

Illustrated in FIG. 3 are two example servers 150. Each of servers 150 may be implemented in any suitable manner, such as by a blade server, computer, stand-alone machine, virtual machine, or any other suitable electronic device. Servers 150 may each implement, fully or in part, system 100 from FIG. 1 and system 120 from FIG. 2. Two servers, server 1 150A and server 2 150B are shown, though any suitable number and kind of servers may be used.

A set of zone shards may be generated for a given security credential. As a result, multiple shards and multiple secrets derived from each shard may be tied to the original security credential.

Each server 150 may include any suitable number and kind of security credentials 170. Security credentials 170 may be used to create shards by zone shard generation function circuit 176. Zone shard generation function circuit 176 may be implemented in any suitable manner, such as by instructions in the medium for execution by the processor, a function, library call, subroutine, shared library, software as a service, analog circuitry, digital circuitry, control logic, digital logic circuits programmed through hardware description language, ASIC, FPGA, PLD, or any suitable combination thereof, or any other suitable mechanism, whether in a unitary device or spread over several devices. Zone shard generation function circuit 176 may implement, fully or in part, system 100 from FIG. 1 and system 120 from FIG. 2. Zone shard generation function circuit 176 may be configured to generate shards into zones, according to how secrets will be derived from the shard and stored.

For a given security credential from security credentials 170, zone shard generation function circuit 176 may be configured to generate a zone 1 shard 172 and a zone 2 shard 178. These may be created using threshold encryption N=T_{N} function circuit 104. Next, secrets from the respective shards may be created and distributed. Once all zone shards have been generated, security credential 170 may be completely and securely destroyed.

Zone 1 shard 172 may be processed by an external secret generation function circuit 166 to create multiple secrets 158, 162. Although only 2 secrets 158, 162 are shown for clarity, any suitable number of secrets may be generated using a threshold encryption X≥T function, such as function circuits 110, 114. Zone 1 shard 172 may be securely destroyed once secrets 158, 162 have been created. Public and private keys may be created through any suitable process. Public keys 152B, 154B may be stored on servers 150. Public key 152B may be used by a PKI function circuit 156 to create an encrypted secret 164 from secret 158. In server 1 150A, this may refer to generating encrypted secret 1-1 164A from secret 1-1 158A. This may be performed by PKI function circuit 156A using public key 152B. In server 2 150B, this may refer to generating encrypted secret 2-1 164B from secret 2-1 158B. This may be performed by PKI function circuit 156B using public key 152B. Notably, the same public key—public key 152B—may be used by both server 1 150A and server 2 150B to encrypt secrets 158 therein to create encrypted secrets 164. Once encrypted secret 164 has been created, secret 158 may be securely destroyed. Encrypted secret 164 may be stored locally.

Similarly, public key 154B may be used by a PKI function circuit 160 to create an encrypted secret 2 168 from secret 2 162. Once encrypted secret 2 168 has been created, secret 2 162 may be destroyed. In server 1 150A, this may refer to generating encrypted secret 1-2 168A from secret 1-2 162A, performed by PKI function circuit 160A using public key 154B. In server 2 150B, this may refer to generating encrypted secret 2-2 168B from secret 2-2 162B, performed by PKI function circuit 160B using public key 154B. Again, the same public key—public key 154B—may be used by both server 1 150A and server 2 150B to encrypt secrets 162 therein to create encrypted secrets 168.

PKI function circuits 156, 160 may be implemented in any suitable manner, such as by instructions in the medium for execution by the processor, a function, library call, subroutine, shared library, software as a service, analog circuitry, digital circuitry, control logic, digital logic circuits programmed through hardware description language, ASIC, FPGA, PLD, or any suitable combination thereof, or any other suitable mechanism, whether in a unitary device or spread over several devices.

Zone 2 shard 178 may be processed by an external secret generation function circuit 182. External secret generation function circuit 182 may be implemented in any suitable manner, such as by instructions in the medium for execution by the processor, a function, library call, subroutine, shared library, software as a service, analog circuitry, digital circuitry, control logic, digital logic circuits programmed through hardware description language, ASIC, FPGA, PLD, or any suitable combination thereof, or any other suitable mechanism, whether in a unitary device or spread over several devices. External secret generation function circuit 182 may be an implementation of function circuit 114. External secret generation function circuit 182 may be configured to generate multiple secrets, such as secret 3 184 and secret 4 180. Although generation of only two such secrets is shown for clarity, multiple secrets can be generated using a threshold encryption X≥T_{X} function such as function circuits 110, 114. Zone 2 shard 178 may be securely deleted once secret 3 184 and secret 4 180 have been created.

Secret 3 184 and secret 4 180 may be securely transmitted to remote storage locations. In one embodiment, secret 3 184 and secret 4 180 may be transmitted and stored on different remote storage locations. For example, secret 1-4 180A may be securely transmitted and stored on remote storage location 1 190, at location 186A. Secret 1-3 184A may be securely transmitted and stored on remote storage location 2 192, at location 188A. Once securely stored, secret 3 184 and secret 4 180 may be securely destroyed.

Servers 150 may reconstitute security credentials through use of keys to first reconstitute the zone shards. At least two external keys may be required to reconstitute zone shards 172, 178 in FIG. 3. However, any number of keys might be required to reconstitute a given shard, depending upon the encryption scheme.

Servers 150 may reconstitute zone 1 shard 172. Encrypted secret 164 may be securely transmitted to an external PKI function circuit 151. Private key 152A may be used by external PKI function circuit 151 to create secret 158 from encrypted secret 164. External PKI function circuit 151 may securely transmit secret 158 back to server 150. External PKI function circuit 151 might require a decryption algorithm corresponding to the encryption function used on server 150. For example, external PKI function circuit 151 may perform decryption corresponding to the encryption that was performed by PKI function circuit 156. Similarly, encrypted secret 168 may be securely transmitted to external PKI function circuit 153. Private key 154A may be used by external PKI function circuit 153 to create secret 162 from encrypted secret 168 and securely transmit it back to server 150. External PKI function circuit 153 might require a decryption algorithm corresponding to the encryption function used on server 150. For example, external PKI function circuit 153 may perform decryption corresponding to the encryption that was performed by PKI function circuit 160. Function circuits 151, 153 may be implemented in any suitable manner, such as by instructions in the medium for execution by the processor, a function, library call, subroutine, shared library, software as a service, analog circuitry, digital circuitry, control logic, digital logic circuits programmed through hardware description language, ASIC, FPGA, PLD, or any suitable combination thereof, or any other suitable mechanism, whether in a unitary device or spread over several devices.

Subsequently, external secret generation function circuit 166 may use secret 158 and secret 162 to recreate zone 1 shard 172. Secret 158 and secret 162 may be securely destroyed once zone 1 shard 172 has been recreated.

Servers 150 may reconstitute zone shard 2 178. Server 150 may retrieve secret 4 186 from remote storage location 1 190, and may store it locally. Secret 3 188 may be retrieved from remote storage location 2 192 and stored locally. Local secret 4 180 and local secret 3 184 may be used together by external secret generation function circuit 182 to generate zone 2 shard 178. Local secret 4 180 and local secret 3 184 may be securely destroyed once zone 2 shard 178 has been created.

Servers 150 may then reconstitute the original security credential 170. Zone 1 shard 172 and zone 2 shard 178 may be used together by zone shard generation function circuit 176 to reconstitute a corresponding security credential 170. Once security credential 170 has been created, zone 1 shard 172 and zone 2 shard 178 may be securely destroyed.

In FIG. 3, it can be seen that there are two zone class types. In one zone the secrets are stored externally to server 150. In the second zone, the external secrets are stored locally in an encrypted state in sever 150. In the second zone, the same public keys 152B, 154B may be each used on each server 150A, 150B to encrypt secrets. Consequently, private keys 152A, 154A can be used to decrypt secrets for either server 150A, 150B. Therefore, in this example, the private key is independent of the server and tied to the owner of that key. However, both private keys 152A, 154A may be required to regenerate zone 1 shard 172 and, consequently, a security credential 170. A zone with this property may be referenced as a device-independent zone or server-independent zone.

However, secrets 1-4 186A and 2-4 186B on remote storage location 1 190 and secrets 1-3 188A and 2-3 188B on remote storage location 2 192 must be provided to their respective server, 150A, 150B. Secret 2-4 186B from remote storage location 1 190 cannot be used on server 150A. Moreover, secret 2-3 188B from remote storage location 2 192 cannot be used on Server 150A. Thus, a zone with this property may be referenced as a device-dependent zone or server-dependent zone.

Thus, in one embodiment, successful reconstitution of security credentials requires one or more server-independent keys and one or more server-dependent secrets to be provided to reconstitute the security credential. The server-independent keys can be realized as physical devices, such as a hardware dongle, smart card, or mobile device app. Thus, a remote credential (a server-independent physical device, for example) and a local credential (a server-dependent credential stored on the remotely located server, for example) may be required to reconstitute the security credentials. This may significantly improve the security of the system when compared to simply storing security credentials 170 themselves. Although server-dependent and server-independent external keys are shown in different zones, it is possible to mix both in the same zone. Doing so may alter the security level of the solution.

Server-independent secrets may allow the owner of the private key to decrypt a locally stored encrypted secret on a server that used the corresponding public key to encrypt it. For example, in FIG. 3, owners of private keys 152A, 154A can successfully recreate zone 1 shard on either server 150A, 150B. However, such owners could not regenerate security credential 170A or security credential 170B unless the corresponding zone 2 shard is also recreated. Zone 2 shard recreation may require server-dependent authorization. An example of how this may be used is as follows. A server 150 may be hosted in a location not operated by the owner of server 150. Private/public key pairs may be realized as a smart card for the private keys. One smart card may be presented to the server owner and a different smart card presented to the location manager. The public keys are used on each server to create locally stored encrypted secrets. These servers 150 may require the local application of the smart card of the owner and that of the location manager to decrypt them. Further, server-dependent secrets are created by the server owner system administrator and also by the location system administrator. These secrets are stored externally. To reconstitute security credential 170, the system administrators must restore the zone 2 shard on a specific server 150. The smart card users can then restore the zone 1 shard on that same server 150. Neither the owners of the smart cards, who must be physically present to use them, or the system administrators working remotely, can reconstitute a security credential on their own. Additionally, the smart card owners need only carry one smart card to participate in the process since that card can decrypt secrets on any server that used corresponding public key to encrypt the secrets. The system prevents remote reconstitution of security credentials without the participation of a local smart card holder. That is, no unattended access is allowed. Similarly, local smart card users cannot reconstitute a security credential without the participation of the system administrators. That is, no unsupervised access might be allowed.

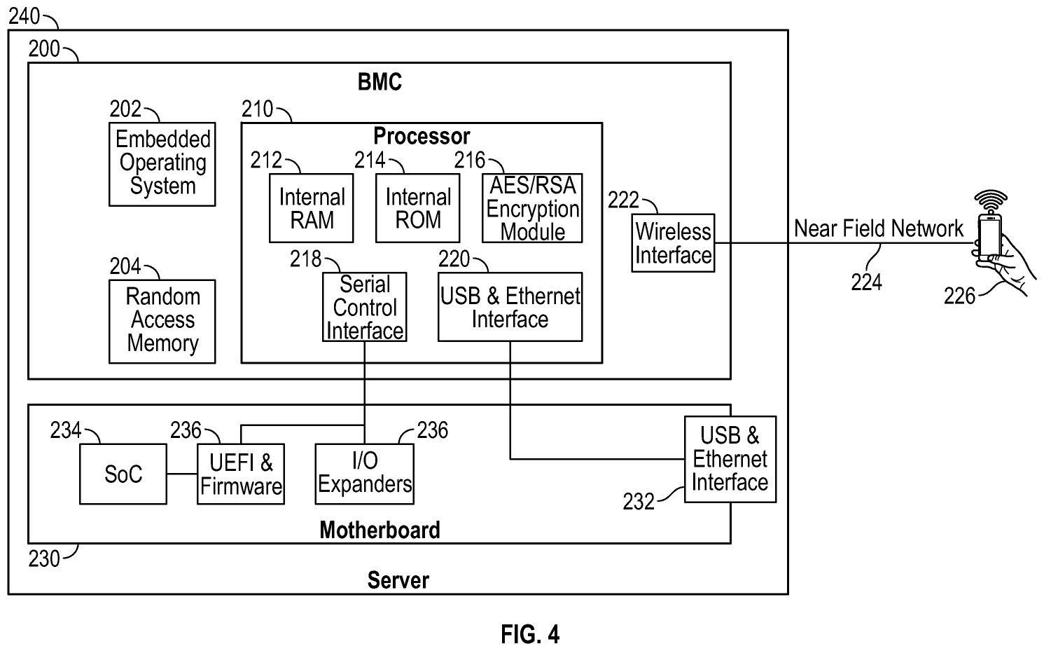

FIG. 4 represents a specific embodiment of the implementation of a smart card solution using Near Field Communications (NFC).

A server 240 can be implemented using two independent processing systems. Server 240 may be an implementation of server 150. A baseboard motherboard controller (BMC) 200 may provide standard BMC functions, such as a server management interface. BMC 200 may be a standalone system and may include a processor 210, embedded operating system 202, random access memory (RAM) 204, and wireless interface 222. Wireless interface 222 may be implemented by analog circuitry, digital circuitry, control logic, instructions for execution by a processor, digital logic circuits programmed through hardware description language, ASIC, FPGA, PLD, or any suitable combination thereof, or any other suitable mechanism, whether in a unitary device or spread over several devices. Wireless interface 222 may be configured to provide a near field network, using NFC, to communicate with an NFC-enabled smart card 226. Motherboard 230 may provide the main processing for server 240 using a System-on-A-Chip (SoC) 234, I/O expanders 238, and UEFI and firmware 236. BMC 200 may communicate to UEFI and firmware 236 via a serial control interface 218 and I/O expanders 238.

BMC processor 210 may have its own AES/RSA encryption function circuit 216 to provide cryptographic functions independently of motherboard 230. Using AES/RSA encryption function circuit 216, together with internal read-only memory (ROM) 214 and internal RAM 212, processor 210 may provide asymmetric encryption, or PKI, functions. Consequently, processor 210 can, for example, implement PKI function circuits 156, 160 for each server 150. Processor 210 may store public keys 152B, 154B locally. Processor 210 may create and store encrypted secrets 164, 168. BMC 200, using processor 210 and wireless interface 222 can then securely transmit a copy of encrypted secrets 164, 168 to the NFC-enabled smart card 226 using near field network 224. NFC-enabled smart card 226 may contain a private key 152 and decrypt encrypted secret 164, 168 transmit it back to BMC 200 via near field network 224. Secret 158, 162 can then be used to compute zone 1 shard 172. Processor 210 can also provide external secret generation 166 function circuit to create secrets 158, 162 from the zone 1 shard 172. Conversely, processor 210 can also provide external secret generation function circuit 166 to reconstitute zone 1 shard 172 from secrets 158, 162 reconstituted using NFC-enabled Smart Card 226.

Using the above embodiment provides two distinct advantages. First, the owner of the public key must be physically close—within a few inches—of wireless interface 222, providing a physical layer of security. Second, generation of secrets 158, 162 and creation and storage of encrypted secrets 164, 168 are isolated from motherboard SoC 234. Motherboard SoC 234 can be used to process the server-dependent secrets and BMC 200 can process the server-independent secrets. This isolation may further prevent a remote administrator from accessing server-independent secrets, or a local smart card owner from access server-dependent secrets, thus preventing unattended and unsupervised access.

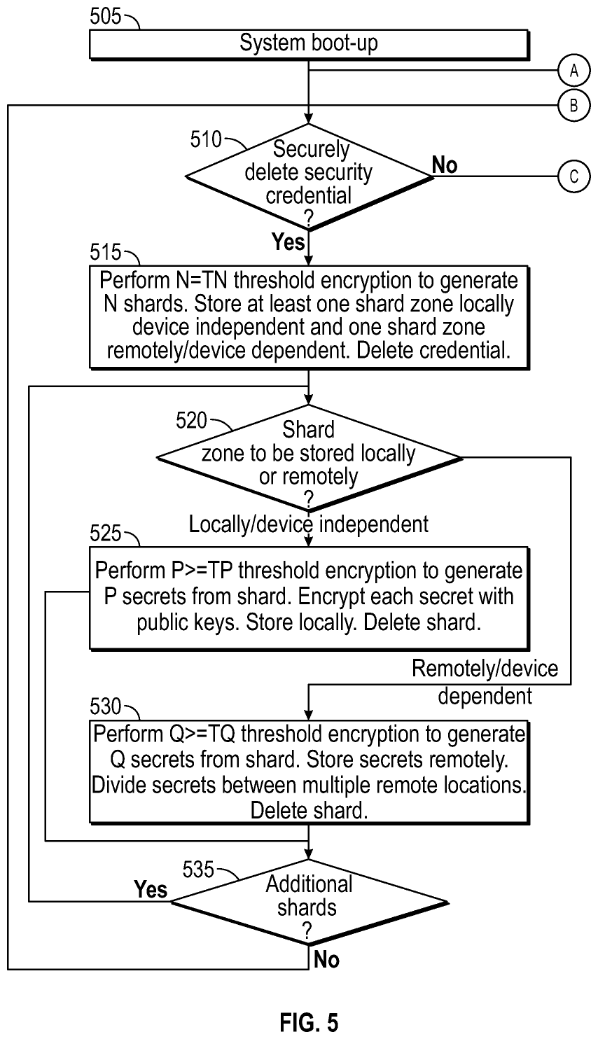

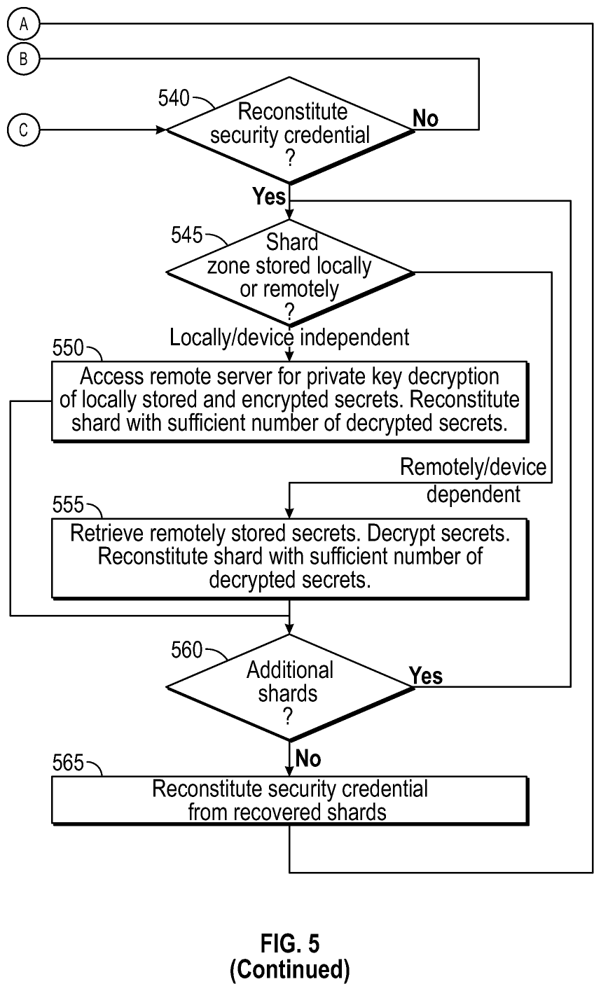

FIG. 5 is an illustration of an example method 500 for security credential destruction and reconstitution, according to embodiments of the present disclosure. Method 500 may be performed by any suitable mechanism, such as by the systems, components, servers, or functions of FIGS. 1-4. Method 500 may begin at any suitable step. Steps of method 500 may be performed in any suitable order, repeated, rearranged, performed recursively, omitted, or performed in parallel.

At 505, a system and servers may boot up. Security credentials may be used and stored.

At 510, it may be determined whether any of the security credentials are to be securely deleted. If so, method 500 may proceed to 515. Otherwise, method 500 may proceed to 540.

At 515, N=T_{N} threshold encryption may be performed to generate N shards from the security credential. At least one of the shards may be stored locally or in a device independent manner, and at least one of the shards may be stored remotely or in a device dependent manner. The security credential may be securely deleted from the server.

At 520, a given shard may be considered. If the shard is to be stored locally or in a device independent manner, method 500 may proceed to 525. If the shard is to be stored remotely or in a device dependent manner, method 500 may proceed to 530.

At 525, P≥T_{P} threshold encryption may be performed to generate P secrets from the shard. Each secret may be encrypted with, for example, public keys. Each encrypted secret may be stored locally. The shard and unencrypted secrets may be securely deleted. Method 500 may proceed to 535.

At 530, Q≥T_{Q} threshold encryption may be performed to generate Q secrets from the shard. Each secret may be encrypted as part of secure transmission to a remote location. Each securely transmitted secret may be stored remotely. Different secrets may be stored in different remote locations. The shard and local unencrypted copies of the secrets may be securely deleted. Method 500 may proceed to 535.

At 535, it may be determined whether additional shards are to be processed. If so, method 500 may return to 520. Otherwise, method 500 may return to 510.

At 540, it may be determined whether any of the security credentials previously deleted are to be reconstituted. If so, method 500 may proceed to 545. Otherwise, method 500 may return to 510.

At 545, it may be determined whether secrets for a given shard of the security credential were stored remotely or in a device dependent manner, or whether the secrets for the given shard were stored locally or in a device independent manner. If the secrets were stored locally or in a device independent manner, method 500 may proceed to 550. If the secrets were stored remotely or in a device dependent manner, method 500 may proceed to 555.

At 550, remote processing may be accessed for private key decryption of the locally stored encrypted secrets. A sufficient number of secrets, albeit a subset of the total secrets generated by the shard, may be returned. The shard may be reconstituted, and the secrets deleted. Method 500 may proceed to 560.

At 555, remotely stored secrets may be retrieved. A sufficient number of secrets, albeit a subset of the total secrets generated by the shard, may be returned. The shard may be reconstituted, and the secrets deleted. Method 500 may proceed to 560.

At 560, it may be determined whether there are additional shards to be reconstituted. If so, method 500 may return to 545. Otherwise, method 500 may proceed to 565.

At 565, the original security credential may be reconstituted from the T_{N} recovered shards. The shards may be deleted. Method 500 may return to 510.

Although example embodiments have been described above, other variations and embodiments may be made from this disclosure without departing from the spirit and scope of these embodiments.

We claim:

1. A system, comprising:
a shard generation circuit configured to:
create a plurality of shards from a security credential; and
recreate the security credential from the plurality of shards;
a first secret generation circuit configured to:
create a plurality of first secrets from a first shard of the plurality of shards;
recreate the first shard of the plurality of shards from a subset of the plurality of secrets; and
store at least one of the plurality of first secrets in a first location; and
a second secret generation circuit configured to:
create a plurality of second secrets from a second shard of the plurality of shards;
recreate the second shard of the plurality of shards from a subset of the plurality of second secrets; and
store at least one of the plurality of second secrets in a second location, the second location in a different machine than the first location.

2. The system of claim 1, wherein the shard generation circuit is configured to destroy the security credential after creation of the plurality of shards as part of a secure erase of data protected by the security credential.

3. The system of claim 1, wherein:
the second location is a remote location to the system; and
the second secret generation circuit is further configured to:
store at least a second one of the plurality of second secrets in a third location, the third location a remote location to the system and in a different machine than the second location.

4. The system of claim 1, wherein the first location is local to the system.

5. The system of claim 1, wherein the plurality of first secrets are independent of a machine on which the secrets reside.

6. The system of claim 1, wherein the plurality of second secrets are dependent upon a machine on which the secrets reside.

7. The system of claim 1, further comprising an encryption circuit configured to encrypt the plurality of first secrets.

8. The system of claim 7, wherein:
the first secret generation circuit is configured to store the plurality of first secrets as encrypted on the system; and
the second secret generation circuit is configured to provide the plurality of second secrets to the second location and a third location.

9. The system of claim 7, wherein the encryption circuit is further configured to apply a different asymmetric encryption credential to each of the plurality of first secrets to encrypt each of the plurality of first secrets.

10. The system of claim 7, wherein a private asymmetric encryption credential corresponding to a public asymmetric encryption credential used to encrypt at least one of the plurality of the first secrets is stored on a remote machine.

11. The system of claim 7, wherein:
the encryption circuit is further configured to:
apply a first asymmetric encryption credential to a first one of the first secrets to encrypt the first one of the first secrets; and
apply a second asymmetric encryption credential to a second one of the first secrets to encrypt the second one of the first secrets;
a first private key corresponding to the first asymmetric encryption credential is stored on a first remote location;
a second private key corresponding to the second asymmetric encryption credential is stored on a second remote location, the second remote location different than the first remote location.

12. The system of claim 11, wherein the asymmetric encryption credentials to encrypt the first secrets are stored internally.

13. The system of claim 1, wherein the security credential is not stored remotely outside of the system.

14. The system of claim 1, wherein the shard generation circuit is further configured to require regeneration of the first shard created as a server-independent shard and regeneration of the second shard created as a server-independent shard in order to recreate the security of shards from a security credential.

15. The system of claim 1, wherein the first secret generation circuit is further configured to recreate the first shard of the plurality of shards only when a minimum number of the subset of the plurality of secrets are presented.

16. The system of claim 1, wherein the first secrets are to be stored internally to the system and are device or server-independent.

17. The system of claim 1, wherein the second secrets are to be stored externally to the system and are device or server-dependent.

18. The system of claim 1, wherein internally stored secrets are only decryptable with a locally provided device.

19. The system of claim 1, wherein the shard generation circuit is configured to erase the security credential after creating the plurality of shards.

20. The system of claim 1, wherein the shard generation circuit is configured to erase plurality of shards after recreating the security credential.

21. The system of claim 1, wherein the first secret generation circuit is configured to erase the first shard after creating the plurality of first secrets.

22. The system of claim 1, wherein the first secret generation circuit is configured to erase the plurality of first secrets after recreating the first shard.

23. The system of claim 1, wherein the second secret generation circuit is configured to erase the plurality of second secrets after storing the plurality of second secrets in the second location.

24. A method, comprising, on a server:
creating a plurality of shards from a security credential;
creating a plurality of first secrets from a first shard of the plurality of shards;
creating a plurality of second secrets from a second shard of the plurality of shards;
storing at least one of the plurality of first secrets in a first location;
storing at least one of the plurality of second secrets in a second location, the second location in a different machine than the first location;
recreating the first shard of the plurality of shards from a subset of the plurality of secrets after retrieval of the at least one of the plurality of first secrets from the first location;
recreating the second shard of the plurality of shards from a subset of the plurality of second secrets after retrieval of the at least one of the plurality of second secrets from the second location; and
recreating the security credential from the plurality of shards as recreated from the first and second secrets.

25. The method of claim 24, further comprising destroying the security credential after creation of the plurality of shards as part of a secure erase of data protected by the security credential.

26. The method of claim 24, wherein:
the second location is a remote location to the system; and
the method further comprises storing at least a second one of the plurality of second secrets in a third location, the third location a remote location to the system and in a different machine than the second location.

27. The method of claim 24, wherein the first location is local to the system.

28. The method of claim 24, wherein the plurality of first secrets are independent of a machine on which the secrets reside.

29. The method of claim 24, wherein the plurality of second secrets are dependent upon a machine on which the secrets reside.

30. The method of claim 24, further comprising encrypting the plurality of first secrets.

31. The method of claim 30, further comprising:
storing the plurality of first secrets as encrypted on the system; and
providing the plurality of second secrets to the second location and a third location.

32. The method of claim 30, further comprising applying a different asymmetric encryption credential to each of the plurality of first secrets to encrypt each of the plurality of first secrets.

33. The method of claim 30, further comprising using a private asymmetric encryption credential, the private asymmetric encryption credential stored on a remote machine, the private asymmetric encryption credential corresponding to a public asymmetric encryption credential, to encrypt at least one of the plurality of the first secrets.

34. The method of claim 30, further comprising:
applying a first asymmetric encryption credential to a first one of the first secrets to encrypt the first one of the first secrets;
applying a second asymmetric encryption credential to a second one of the first secrets to encrypt the second one of the first secrets;
storing a first private key corresponding to the first asymmetric encryption credential in a first remote location; and
storing a second private key corresponding to the second asymmetric encryption credential in a second remote location, the second remote location different than the first remote location.

35. The method of claim 34, further comprising storing the asymmetric encryption credentials to encrypt the first secrets internally in the server.

36. The method of claim 24, wherein the security credential is not stored remotely outside of the system.

37. The method of claim 24, further comprising requiring regeneration of the first shard created as a server-independent shard and regeneration of the second shard created as a server-independent shard in order to recreate the security of shards from a security credential.

38. The method of claim 24, further comprising recreating the first shard of the plurality of shards only when a minimum number of the subset of the plurality of secrets are presented.

39. The method of claim 24, further comprising storing the first secrets are internally to the system, wherein the first secrets are device or server-independent.

40. The method of claim 24, further comprising storing the second secrets externally to the system, wherein the second secrets are device or server-dependent.

41. The method of claim 24, further comprising requiring internally stored secrets to be decrypted with a locally provided device, the device separate from the system.

42. The method of claim 24, further comprising erasing the security credential after creating the plurality of shards.

43. The method of claim 24, further comprising erasing plurality of shards after recreating the security credential.

44. The method of claim 24, further comprising erasing the first shard after creating the plurality of first secrets.

45. The method of claim 24, further comprising erasing the plurality of first secrets after recreating the first shard.

46. The method of claim 24, further comprising erasing the plurality of second secrets after storing the plurality of second secrets in the second location.
